(19) United States
(12) Patent Application Publication
(10) Pub. No.: US 2004/0210536 A1
(43) Pub. Date: Oct. 21, 2004

(54) Cross-domain transactions through simulated pop-ups

(76) Inventors: Tino Gudelj, Pleasanton, CA (US); Robert Roy Allen, Palo Alto, CA (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/739,825

(22) Filed: Dec. 17, 2003

Related U.S. Application Data
(60) Provisional application No. 60/434,765, filed on Dec. 18, 2002.

(51) Int. Cl. G06F 17/60

(52) U.S. Cl. 705/64; 705/39

(57) ABSTRACT

In cross-domain transactions, a user communicates with multiple distinct domains. For example, in an authenticated online credit card purchase, the user supplies a credit card number to a merchant's web page, and is thereafter sent (via a pop-up window) to an issuing bank's access control server to provide a password to the issuing bank. The server verifies the password and returns a transaction authorization to the user (via the pop-up), who forwards the authorization to the merchant. If the user's computer includes a pop-up killer, the communication channel between the user's browser and the issuing bank (i.e., the pop-up) is eliminated, preventing authentication and transaction authorization. This patent discloses techniques for creating a simulated pop-up window that resists automatic termination by pop-up killers, so that the cross-domain transaction can proceed in spite of the pop-up killer.

This patent claims the priority of U.S. provisional patent application No. 60/434,765 filed on Dec. 18, 2002.

### FIELD

This patent relates generally to facilitating cross-domain transactions in an Internet (or equivalent) environment. More specifically, this patent relates to the use of simulated pop-up windows, allowing communication with a second domain, to appear within an existing window in communication with the first domain.

### BACKGROUND

A. Cross-Domain Transactions Generally

On a decentralized network, such as the Internet, users often interact with service providers across distinct web domains. A web service provider—referred to as service provider A—located at one or more distinct web domains, may offer services that are actually provided by (or at least relate to services by) another or the same service provider located in a separate web domain or domains—referred to as the service provider B. For example, a transaction between a user and service provider A to access to confidential information, to make purchases, or in still other contexts, may require identity validation to be provided by service provider B. In the Internet environment, the interaction between service provider A and service provider B occurs through a web browser interface.

Online transactions between service provider A and service provider B, as described above, occur across two or more distinct web domains, and may therefore be regarded as cross-domain transactions. Since cross-domain transactions interact with two distinct web domains, the Internet web browser is required to process information within two distinct browser window entities. The browser window entities, in their conventional form, are composed of a (or primary) main window, which is in the domain of service provider A, and a pop-up window, which is in the domain of service provider B.

Some drawbacks of having two (or more) distinct browser windows may include some or all of the following:

1. Pop-up killer software often eliminates web browser pop-up windows—obscuring the flow of a cross-domain transaction. Further, there is currently no definitive technique for detecting pop-up killer software from within a conventional web browser, using currently available scripting languages such as JavaScript or VBScript.

2. Even absent a pop-up killer, users may not notice that a pop-up window has appeared (for example, because the user's desktop settings are configured such that the pop-up appears below another window or in minimized form).

3. Even if the user notices the pop-up window, the user may mistakenly interpret it as an annoying advertisement (and therefore ignore it) rather than a required part of the transaction. The user may even close the browser pop-up window entirely.

4. The user (or the user's pop-up killer or other software on the user's computer) may in some other manner inhibit the flow of a cross-domain transaction.

B. Operation of an Exemplary Conventional Cross-Domain Transaction Absent a Pop-Up Killer

One particular example of a cross-domain transaction is Visa's 3-D secure (also known as “Verified by VISA”) online transaction, whereby Internet users use credit cards to purchase goods or services from merchants, including authenticating themselves with the bank that issued them their credit cards. Throughout the course of Visa's 3-D secure online transaction, the web browser communicates with two distinct web domains—the merchant's web domain, and the bank's web domain. In the conventional 3-D secure implementation, the user-merchant interaction occurs in the main window, and verification of cardholder identity to the bank occurs via the pop-up window.

The following paragraphs illustrate in greater detail a typical conventional implementation illustrating the interaction between the user's browser and the merchant and bank computers.

The user, at his/her browser (i.e., at the main browser window), visits a merchant's web page, decides to make a purchase, and securely transmits his/her payment information (e.g., credit card data) to the merchant's purchase confirmation page.

Then, software at merchant's web site (or e-commerce server) queries a directory server operated by Visa (or one of its member banks) to verify that the user participates in 3D Secure protocol. Assuming the answer is yes, the directory server returns to the merchant a uniform resource locator (URL) of an access control server (ACS) of the bank that issued the user's card (the so-called issuing bank). The merchant-directory server interaction is transparent to the user, and is not directly relevant to this patent.

The merchant's software then forwards a message—typically implemented using JavaScript or any other type of programming language which enables executable content to be distributed over the Internet—directing the user's browser to transfer a so-called payment request (PAReq) to the ACS. Because the PAReq is sent from the user's browser to the ACS, the ACS acquires enough location information (for example and without limitation, the IP address and port number of the user's Web browser) to be able to communicate directly with the user's browser. Browser script at the user's computer opens a browser pop-up window and establishes communication with the ACS, which transmits a request to the user's browser for an authentication password (or PIN, etc.).

The user supplies the ACS with the requested password via the pop-up window. Around this time, the merchant's web site typically performs a “history back” operation that returns the user's active window to the purchase confirmation page (in the main browser window), while still maintaining the pop-up window. The history back operation tells the browser to go back one item in the history list, returning the user to the page he/she came from (the purchase confirmation page), while keeping the pop-up window viewable.

After the ACS verifies the user-supplied password, it generates a message including a payer authentication response (PARes) and forwards the message to the user's browser (via the pop-up window), instructing the cardholder's Web browser to forward the PARes to the merchant. Included in the PARes is an indication whether the transaction has been verified by the ACS.

The merchant then transmits transaction processing information to the bank serving its credit card transactions (the so-called acquiring bank), which forwards the information to the issuing bank to authorize the purchase. Finally, the merchant informs the cardholder (at the main browser window) that the transaction was successful.

C. Impairment of an Exemplary Conventional Cross-Domain Transaction Due to a Pop-Up Killer

The following paragraphs illustrate a typical scenario that may occur whereby a cross-domain transaction is inhibited by an active pop-up killer.

As before, when the user clicks on the “buy” button on the merchant's purchase confirmation page, the merchant web site returns a PAReq to the user's browser so that the user can be authenticated as a precondition to continuing the transaction. Again, browser script attempts to open a browser pop-up window through which to communicate with the ACS (i.e., to receive the password request & to provide the requested password).

In this case, however, the pop-up killer would eliminate the pop-up window, so that the cardholder is left with only the purchase confirmation page (from the “history back” operation), without the required identity confirmation having occurred, or perhaps having been terminated prematurely.

If the user does not realize why the pop-up window did not appear (i.e., due to a pop-up killer), the user may click on the buy button again, trying to complete the transaction. But each time, the result will be the same. Frustrated, the user may simply abandon the purchase.

D. Mitigation Techniques

One known way to mitigate this problem is for the ACS to track responses to its auto-enrollment transactions. Auto-enrollment is a procedure, initiated before or at the beginning of a transaction, when the directory server reports to the merchant that the user is not a current participant in the 3-D secure program. In that case, the user (typically through the merchant) is prompted to enroll.

In one implementation of the ACS (available from Arcot Systems), when the ACS instigates the auto-enrollment sequence for an unenrolled cardholder, it tracks the result in a database. If a pop-up-killer is enabled, the ACS will receive the PAReq from the browser, and request the user's password (e.g., though a pop-up), but no response will be received at the ACS.

Thus, for those auto-enrollment transactions where the ACS only receives a PAReq but does not receive any other response from the cardholder, the ACS tallies a mark on the cardholder's account. If the cardholder tallies two marks in a row, then the ACS marks the account as “hostile to auto-enrollment” and thereafter ceases instigating the auto-enrollment sequence. After a couple of attempts, the cardholder would be able to proceed with the purchase as a non-enrolled card. This is not an optimal solution because, even though the transaction ultimately proceeds, it does so without authentication (and therefore at increased risk).

A better solution to the example mentioned above, would be to enable the web browser to simulate a pop-up window that resists automatic termination by pop-up killer software, and that is unlikely to be inadvertently closed, or to be misplaced, by an Internet user.

### SUMMARY

In cross-domain transactions, a user often must communicate with two distinct domains, say, service providers A and B. For example, in an authenticated online credit card purchase, the user supplies his/her credit card number to a merchant's web page (service provider A), and is thereafter sent to a third party access control server web page (service provider B) via a pop-up window to authenticate the user's identity (e.g., though a password or otherwise) to the credit card issuer. The issuer verifies the user's identity, and returns a transaction authorization to the user (via the pop-up), which then forwards the authorization to the merchant (through the main browser window).

If the user's computer includes an active pop-up killer, the communication channel between the user's browser and the credit card issuer is eliminated, preventing authentication and transaction authorization.

This patent discloses techniques for creating a simulated pop-up window that resists automatic termination by pop-up killers (at least as presently known in the art), so that the cross-domain transaction can proceed in spite of the pop-up killer. The simulated pop-up is not a real web browser window (i.e., it is not a separate process that exists independently of the web browser or the main browser window). Nevertheless, if desired, the pop-up window can be configured to maintain the look-and-feel of a real web browser window that interacts with the main browser window.

The simulated pop-up window serves a substitute communications channel, in place of the conventional (real) pop-up window, that provides a direct connection to service provider B, so that information can flow between (i.e., to/from) the user's browser and service provider B just as if there had been an actual pop-up absent a pop-up killer.

More specifically, this patent discloses (but is not limited to) three exemplary techniques for creating a simulated pop-up window: (1) through use of a web browser inline frame defined by the HTML <IFRAME> tag; (2) through use of regular web browser frames defined using the HTML <FRAMESET> and <FRAME> tags that may be configured to look like a distinct window; and (3) through use of a Java (or other) applet that acts like a web browser window with the characteristics of a simulated pop-up.

### BRIEF DESCRIPTION OF THE FIGURES

FIG. 1 conceptually illustrates the distinction between the conventional approach to cross-domain transactions, and the simulated pop-up approach of this patent.

FIG. 2 illustrates one exemplary implementation of a simulated pop-up window.

FIG. 3 illustrates another exemplary implementation of a simulated pop-up window.

### DETAILED DESCRIPTION

U.S. provisional patent application No. 60/434,765, filed on Dec. 18, 2002, is hereby incorporated by reference in its entirety.

A. Increased Reliability Through Constrained Dependency

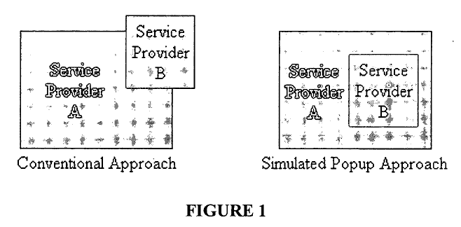

The simulated pop-up approach to cross-domain transactions provides increased assurance, to both service provider A and service provider B, that the Internet users will be able to complete the transactions in a reliable manner. FIG. 1 conceptually illustrates the distinction between conventional and the simulated pop-up approach to cross-domain transactions.

The domain squares in FIG. 1 represent the dependency of distinct web domain entities within a web browser interface. In the conventional approach closing the browser window containing content associated with (i.e., to or from) either service provider would have no effect on the browser window containing content associated with the other service provider. Hence, if a pop-up killer closes or prevents the window for service provider B, the user at the window for service provider A could be left wondering why the window for service provider B never appeared.

Unlike the conventional pop-up window, a simulated pop-up is an integral part of the main web browser window, meaning that the former is the latter's direct dependent. Hence, the simulated pop-up should not be killed by pop-up killers (at least as presently known in the art), and the cross-domain transaction can proceed in spite of the pop-up killer.

Even though the simulated pop-up is not a real web browser window (i.e., not a separate process that exists independently of the web browser or the main browser window), it can be configured to maintain the look-and-feel of a real web browser window that interacts with the main browser window. In any of the cases, the simulated pop-up can be implemented to include custom event handling code to mimic standard window events such as minimizing, maximizing, and closing.

The simulated pop-up is configured to provide a direct connection to service provider B, so that the flows occur just as if they would have occurred with an actual pop-up. The simulated pop-up substitutes for the real pop-up as a communications channel between the user and service provider B.

The following sections illustrate three exemplary embodiments of creating and displaying a simulated pop-up. All three of these exemplary embodiments are constructed using currently HTML tools, for example, those available within the HTML 4.0 protocol as specified by the W3C organization.

B. First Exemplary Embodiment of a Simulated Pop-Up

As a first example, a simulated pop-up may be created by a web browser inline frame using the HTML <IFRAME> tag. The <IFRAME> tag allows a frame to be created, and floated atop the main browser window, analogously to embedding an image using the <IMG> tag.

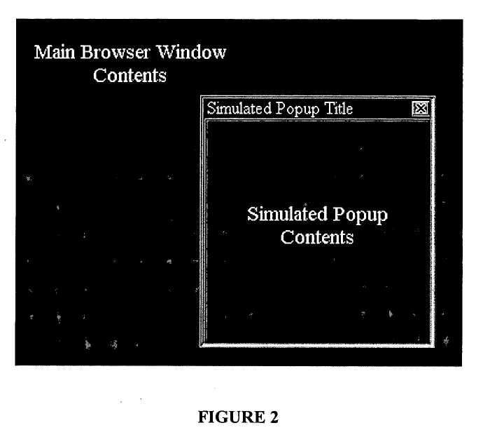

FIG. 2 illustrates an exemplary simulated pop-up defined by an inline frame on a computer screen.

The inline frame is then placed into communication with service provider B, using standard HTML techniques (similar to the conventional pop-up case) to receive information therefrom, and/or to pass information thereto.

For example, if service provider A is in communication with the main browser window, then information from service provider A can be contained within a form of the main browser window—defined by the HTML <FORM> tag. This form might, for example, include information received from the merchant per se, or after having communicated with a third party server that verifies the user's participation in a secure credit card authentication protocol.

The form contents can be posted from the main browser window to service provider B by using the inline frame as an HTML target. By establishing the inline frame as a target, frames (such as the main browser window) can post information (including services) to service provider B via the inline frame.

Conversely, information (including services) from service provider B would also be made available to the user via the simulated pop-up (i.e., inline frame), and information (including services) from service provider B (e.g., a transaction authorization) could be transferred to service provider A using standard techniques (HTML, JavaScript, etc.)

The inline frame can be configured to simulate the look-and-feel of a real window, by using a HTML DIV tag as its wrapper object. In one exemplary implementation, the DIV tag posses a distinct border, characteristic to most computer windows. The border is defined by the border-style property of the DIV tag. As it is contained within the DIV tag, the inline frame may be dragged around with a mouse—similarly to a real window. The exemplary DIV tag mentioned above also embeds an image of a window close button and a window title. More generally, attributes of the DIV tag allow the system designed to specify desired actions to occur based on mouseover, mouseout, keypress, keydown, keyup, and still other triggering events. Similarly, the inline frame can include custom event handling code to mimic standard window events such as minimizing, maximizing, and closing.

Details and use of the <IFRAME>, <FORM>, <DIV> and still other HTML tags- as well as their HTML attributes that may be used to control how and where they are displayed and manipulated—are well known to those skilled in the art of HTML programming, and need not be described in greater detail herein.

C. Second Exemplary Embodiment of a Simulated Pop-Up

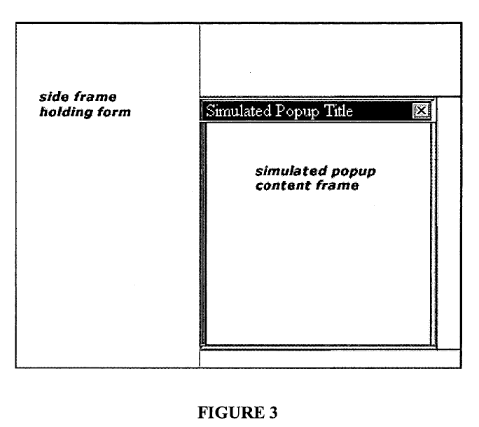

As a second example, a simulated pop-up may be created by defining a web browser page using the HTML <FRAMESET> tag, and specifying individual (or child) frames within the frameset using HTML <FRAME> tags. FIG. 3 shows the outlines of a frameset that creates a simulated pop-up within a main browser window.

The simulated pop-up appears to be superimposed on top of the main browser window (as in the conventional case as well as in the case of FIG. 2). In fact, the main browser window is embedded in the same plane as the simulated pop-up. Thus, in this exemplary embodiment, the main browser window may be regarded as having a hole into which the simulated pop-up fits.

Thus, the overall frameset includes certain frames defining a simulated pop-up, surrounded by other frames defining what appears to be a main browser window. The frameset of FIG. 3 creates a simulated pop-up within a main browser window using nine child frames. Four of these child frames define the main browser window, and five more define the simulated pop-up.

The four child frames defining the main browser window are (proceeding clockwise from the left): (1) a predominantly vertical side frame at the left; (2) a predominantly horizontal unlabelled frame at the top right; (3) a predominantly vertical unlabelled frame at the right; and (4) a predominantly horizontal unlabelled frame at the bottom right (aligned directly under the second child frame).

The five child frames defining the simulated pop-up are (proceeding clockwise from the left): (1) a vertical border at the left; (2) a horizontal title box at the top; (3) a vertical border at the right; (4) a predominantly vertical unlabelled frame at the right; and (5) a content area for the simulated pop-up at the center.

Information from service provider A is contained within a form in one of the side frame windows (part of the main browser window)—again defined by the HTML <FORM> tag. In the exemplary implementation of FIG. 2, the form is held in the predominantly vertical side frame at the left of the simulated pop-up. As before, the form contents may be posted from the side frame holding the form to service provider B with the simulated pop-up content frame as the target.

As before, the simulated pop-up allows also information (including services) from service provider B to be made available to the user, and information (including services) from the simulated pop-up to be transferred back to the main browser window.

As before, this exemplary frameset contains a series of frames surrounding the simulated pop-up content frame that maintain the look-and-feel of a real window by containing graphics that mimic a distinct border and title area characteristic to most computer windows. The title area embeds an image of a window close button and a window title text. That is, the simulated pop-up can include custom event handling code to mimic standard window events such as minimizing, maximizing, and closing.

Details and use of the <FRAMESET>, <FRAME>, <FORM> and still other HTML tags—as well as their HTML attributes that may be used to control how and where they are displayed and manipulated—are well known to those skilled in the art of HTML programming, and need not be described in greater detail herein.

D. Third Exemplary Embodiment of a Simulated Pop-Up

As a third example, another way of creating a simulated pop-up is to use a Java applet. The applet program is configured to create a window whose contents the applet controls within the browser main window.

The applet is a program that is automatically downloaded from service provider A, and executed by the user's browser environment, when either the <APPLET> or <OBJECT> tag is provided in service provider A's web page. In one exemplary implementation, the applet program is cryptographically “signed” by a trusted third party in order to allow secure and trusted communications between the applet program and the browser environment.

Information from service provider A is initially provided into the main browser window that also contains the <APPLET> or <OBJECT> tag. The window contents also include JavaScript, that communicates with the running applet, and is used to subsequently pass such information to the applet. After the information is provided, the JavaScript indicates that the applet should establish communications with service provider B.

The information is sent to service provider B by the applet. More specifically, the applet posts the information using its own window (i.e., the pop-up created by the applet) as the target.

As before, the simulated pop-up window allows information (including services) from service provider B to be available to the Internet user, and information (including services) from the simulated pop-up to be transferred to the main browser window.

Depending on design choice, the simulated pop-up created in this fashion can be the same as (or different than) to that resulting from the <IFRAME> approach shown in FIG. 1. The applet's window implementing the simulated pop-up can maintain the look-and-feel of a real browser window by containing graphics that mimic a distinct border and title area characteristic to most computer windows. The simulated pop-up can also include custom event handling code to mimic standard window events such as minimizing, maximizing, and closing.

E. Merchant Plug-In

All of the foregoing (inline frame, frameset, and applet) techniques for creating simulated pop-ups involve code (HTML, JavaScript, etc.) that is downloaded from the merchant to the user's browser. Such code can, for example and without limitation, be deployed in the form of a merchant plug-in, or using still other techniques known to those skilled in the art. The merchant plug-in can be conveyed to the merchant through any standard technique, and can be stored on any computer-readable medium, including without limitation, floppy disks, hard disks, CDs, RAM, ROM, or the like.

F. Conclusion

As a matter of convenience, the techniques of this patent have been disclosed in the exemplary context of a web-based system in which the user accesses applications browser. However, those skilled in the art will readily appreciate that other user access devices may also be used. For example, certain cell phones, PDAs, and other consumer electronics devices already have the capability to access the Internet. In addition, it is expected that over time, that still other devices and appliances will also be able to access applications over the Internet. Thus, the term browser should be interpreted broadly to include any kind of interface capable of accessing information accessible over a network, rather than merely conventional PC-based browsers. Similarly, it should be appreciated that the proposed techniques will operate on any networked computer, including without limitation, wireless networks, handheld devices, personal computers and others. It should also be understood that, although the exemplary embodiments herein have been disclosed in the context of HTML and/or JavaScript, other current or future techniques could also be used. For example and without limitation, these might include XML, Macromedia's Shockwave, Macromedia's Flash, and the Curl content language.

What is claimed is:

1. A method for enabling cross-domain electronic transactions involving a first party at a first domain, a second party at a second domain, and a user at a user domain, comprising the steps of:
(a) transmitting, from a first computer at said first domain across a network to a user computer at said user domain, computer-executable logic instructions for creating a simulated pop-up window that is
(i) visually perceivable as distinct from a main browser window of said user computer,
(ii) resistant to termination by pop-up killer software running on said user computer, and
(iii) usable by said user to open a communication channel with a second computer at said second domain; and
(b) transmitting, from said first computer to said user computer, information to be forwarded to said second computer via said communication channel associated with said simulated pop-up window;
thereby enabling an electronic transaction involving said first party at said first domain, said second party at said second domain, and said user at said user domain.

2. The method of claim 1 further comprising, at said first computer:
(c) receiving a communication from said user computer, based on a transmission from said second computer via said simulated pop-up window to said user computer.

3. The method of claim 2 further comprising, at said first computer:
(d) taking an action based on said receipt of said communication from said user computer.

4. The method of claim 1 where said computer-executable browser instructions include browser script.

5. The method of claim 4 where said browser script includes instructions for creating said simulated pop-up window as an inline frame relative to said main browser window.

6. The method of claim 4 where said browser script includes instructions for creating a frameset involving (i) a first plurality of frames representing said main browser window, and (ii) at least one frame representing said simulated pop-up within said main browser window.

7. The method of claim 4 where said computer-executable browser instructions include an applet configured to create and control said simulated pop-up window.

8. The method of claim 7 where said applet is cryptographically signed to ensure security.

9. The method of claim 3 where said information forwarding in (b) is implemented by posting said information to said simulated pop-up as a designated target.

10. The method of claim 7 further comprising, at said first computer:
(c) transmitting to said user computer a computer-executable script configured (i) to communicate with said applet, and (ii) to pass to said applet said information in (b).

11. The method of claim 10 where said computer-executable script includes JavaScript.

12. The method of claim 1 where said simulated pop-up is configured to mimic, at least in part, a look-and-feel of a real pop-up window.

13. The method of claim 1 where said simulated pop-up window may be dragged by said user using a control device.

14. The method of claim 1 where said simulated pop-up window may be closed by said user.

15. The method of claim 1 including the use of non-HTML programming techniques to implement said simulated pop-up window.

16. The method of claim 1 where (i) said first party includes a merchant performing a financial transaction with said user, and (ii) said second party includes a payment authorizer for said transaction.

17. A computer-readable medium containing computer logic instructions for enabling cross-domain electronic transactions involving a first party at a first domain, a second party at a second domain, and a user at a user domain, said logic instructions when executed:
(a) transmitting, from a first computer at said first domain across a network to a user computer at said user domain, computer-executable logic instructions for creating a simulated pop-up window that is
(i) visually perceivable as distinct from a main browser window of said user computer,
(ii) resistant to termination by pop-up killer software running on said user computer, and
(iii) usable by said user to open a communication channel with a second computer at said second domain; and
(b) transmitting, from said first computer to said user computer, information to be forwarded to said second computer via said communication channel associated with said simulated pop-up window;
thereby enabling an electronic transaction involving said first party at said first domain, said second party at said second domain, and said user at said user domain.

18. The computer-readable medium of claim 17 further comprising logic instructions that, when executed:
(c) cause said first computer to receive a communication from said user computer, based on a transmission from said second computer via said simulated pop-up window to said user computer.

19. The computer-readable medium of claim 17 further comprising logic instructions that, when executed:
(d) cause said first computer to take an action based on said receipt of said communication from said user computer.

20. The computer-readable medium of claim 17 where said computer-executable browser instructions include browser script.

21. The computer-readable medium of claim 20 where said browser script includes instructions for creating said simulated pop-up window as an inline frame relative to said main browser window.

22. The computer-readable medium of claim 20 where said browser script includes instructions for creating a frameset involving (i) a first plurality of frames representing said main browser window, and (ii) at least one frame representing said simulated pop-up within said main browser window.

23. The computer-readable medium of claim 20 where said computer-executable browser instructions include an applet configured to create and control said simulated pop-up window.

24. The computer-readable medium of claim 17 where said simulated pop-up is configured to mimic, at least in part, a look-and-feel of a real pop-up window.

25. The computer-readable medium of claim 17 where (i) said first party includes a merchant performing a financial transaction with said user, and (ii) said second party includes a payment authorizer for said transaction.

26. The computer-readable medium of claim 17 implemented as a plug-in component usable with said first party's preexisting computer system.

27. An apparatus for enabling cross-domain electronic transactions involving a first party at a first domain, a second party at a second domain, and a user at a user domain, comprising:
(a) means for transmitting, from a first computer at said first domain across a network to a user computer at said user domain, computer-executable logic instructions for creating a simulated pop-up window that is
(i) visually perceivable as distinct from a main browser window of said user computer,
(ii) resistant to termination by pop-up killer software running on said user computer, and
(iii) usable by said user to open a communication channel with a second computer at said second domain; and
(b) means for transmitting, from said first computer to said user computer, information to be forwarded to said second computer via said communication channel associated with said simulated pop-up window;
thereby enabling an electronic transaction involving said first party at said first domain, said second party at said second domain, and said user at said user domain.

28. The apparatus of claim 27 further comprising:
(c) means for causing said first computer to receive a communication from said user computer, based on a transmission from said second computer via said simulated pop-up window to said user computer.

29. The apparatus of claim 27 further comprising:
(d) means for causing said first computer to take an action based on said receipt of said communication from said user computer.

30. A method for enabling cross-domain electronic transactions involving a user at a user domain, a first party at a first domain, and a second party at a second domain, comprising the steps of:
(a) at a user computer at said user domain, receiving from a first computer at said first domain, computer-executable logic instructions for creating a simulated pop-up window at said user computer that is
(i) visually perceivable as distinct from a main browser window of said user computer,
(ii) resistant to termination by pop-up killer software running on said user computer, and
(iii) usable by said user computer to open a communication channel with a second computer at said second domain; and
(b) at said user computer, receiving from said first computer, information to be forwarded to said second computer via said communication channel associated with said simulated pop-up window;
thereby enabling an electronic transaction involving said first party at said first domain, said second party at said second domain, and said user at said user domain.

31. The method of claim 30 further comprising, at said user computer:
(c) receiving a transmission from said second computer via said simulated pop-up window; and
(d) sending a communication to said first computer based on said received transmission.
